(19) United States
(12) Patent Application Publication
(10) Pub. No.: US 2025/0365654 A1
(43) Pub. Date: Nov. 27, 2025

(54) CONFLICT RESOLUTION IN WIRELESS COMMUNICATION SYSTEM

(71) Applicant: LG ELECTRONICS INC., Seoul (KR)

(72) Inventors: Hongsuk KIM, Seoul (KR); Sunghoon JUNG, Seoul (KR)

(73) Assignee: LG ELECTRONICS INC., Seoul (KR)

(21) Appl. No.: 18/873,697

(22) PCT Filed: Jun. 21, 2023
(86) PCT No.: PCT/KR2023/008592

§ 371 Date: Dec. 10, 2024

Related U.S. Application Data
(60) Provisional application No. 63/353,852, filed on Jun. 21, 2022.

(51) Int. Cl. H04W 48/18; H04W 24/10; H04W 60/00

(52) U.S. Cl. CPC H04W 48/18; H04W 24/10; H04W 60/005

(57) ABSTRACT

The present disclosure relates to conflict resolution in wireless communications. According to an embodiment of the present disclosure, a method performed by a user equipment (UE) configured to operate in a wireless communication system comprises: establishing a connection with a first network; receiving, from the first network, a release message comprising information for a frequency list; obtaining measurement results for frequencies in the frequency list, after releasing or suspending the connection with the first network; establishing a connection with a second network; performing operations on a serving frequency of the second network based on the connection with the second network; and based on at least one first frequency in the frequency list conflicting the serving frequency of the second network, transmitting, to the first network, a message comprising measurement results for at least one second frequency other than the at least one first frequency in the frequency list.

### CROSS-REFERENCE TO RELATED APPLICATION(S)

This application is the National Stage filing under 35 U.S.C. 371 of International Application No. PCT/KR2023/008592, filed on Jun. 21, 2023, which claims the benefit of U.S. Provisional Application No. 63/353,852, filed on Jun. 21, 2022, the contents of which are all incorporated by reference herein in their entirety.

### TECHNICAL FIELD

The present disclosure relates to conflict resolution in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a user equipment (UE) may perform operations using radio resources e.g., first radio resource and second radio resource. However, there may be a case UE's capability does not support simultaneously performing operations on a first radio resource and operations on a second radio resource. This may be referred to as there is a capability conflict between the first radio resource and the second radio resource, and/or the first radio resource conflicts the second radio resource. Conflict may occur various situations, such as in multiple networks related to multiple universal subscriber identity module (MUSIM) operations.

### SUMMARY

An aspect of the present disclosure is to provide method and apparatus for conflict resolution in a wireless communication system.

Another aspect of the present disclosure is to provide method and apparatus for conflict resolution in MUSIM operations in a wireless communication system.

Yet another aspect of the present disclosure is to provide method and apparatus for measurement reporting for conflict resolution in a wireless communication system.

According to an embodiment of the present disclosure, a method performed by a user equipment (UE) configured to operate in a wireless communication system comprises: establishing a connection with a first network; receiving, from the first network, a release message comprising information for a frequency list; obtaining measurement results for frequencies in the frequency list, after releasing or suspending the connection with the first network; establishing a connection with a second network; performing operations on a serving frequency of the second network based on the connection with the second network; and based on at least one first frequency in the frequency list conflicting the serving frequency of the second network, transmitting, to the first network, a message comprising measurement results for at least one second frequency other than the at least one first frequency in the frequency list.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: establishing a connection with a first network; receiving, from the first network, a release message comprising information for a frequency list; obtaining measurement results for frequencies in the frequency list, after releasing or suspending the connection with the first network; establishing a connection with the second network; performing operations on a serving frequency of the second network based on the connection with a second network; and based on at least one first frequency in the frequency list conflicting the serving frequency of the second network, transmitting, to the first network, a message comprising measurement results for at least one second frequency other than the at least one first frequency in the frequency list.

According to an embodiment of the present disclosure, a network node in a first network configured to operate in a wireless communication system comprises: at least one transceiver; at least one processor; and at least one memory operatively coupled to the at least one processor and storing instructions that, based on being executed by the at least one processor, perform operations comprising: establishing a connection with a user equipment (UE); transmitting, to the UE, a release message comprising information for a frequency list; transmitting, to the UE, a request to report measurement results for the frequency list; and receiving, from the UE, a message comprising measurement results for at least one second frequency other than at least one first frequency in the frequency list, wherein the at least one first frequency conflicts a serving frequency of a second network, and wherein the UE is configured to establish a connection with the second network and perform operations on the serving frequency of the second network based on the connection with the second network.

According to an embodiment of the present disclosure, a method performed by a network node in a first network configured to operate in a wireless communication system comprises: establishing a connection with a user equipment (UE); transmitting, to the UE, a release message comprising information for a frequency list; transmitting, to the UE, a request to report measurement results for the frequency list; and receiving, from the UE, a message comprising measurement results for at least one second frequency other than at least one first frequency in the frequency list, wherein the at least one first frequency conflicts a serving frequency of a second network, and wherein the UE is configured to establish a connection with the second network and perform operations on the serving frequency of the second network based on the connection with the second network.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: establishing a connection with a first network; receiving, from the first network, a release message comprising information for a frequency list; obtaining measurement results for frequencies in the frequency list, after releasing or suspending the connection with the first network; establishing a connection with a second network; performing operations on a serving frequency of the second network based on the connection with the second network; and based on at least one first frequency in the frequency list conflicting the serving frequency of the second network, transmitting, to the first network, a message comprising measurement results for at least one second frequency other than the at least one first frequency in the frequency list.

According to an embodiment of the present disclosure, a non-transitory computer readable medium (CRM) has stored thereon a program code implementing instructions that, based on being executed by at least one processor, perform operations comprising: establishing a connection with a first network; receiving, from the first network, a release message comprising information for a frequency list; obtaining measurement results for frequencies in the frequency list, after releasing or suspending the connection with the first network; establishing a connection with a second network; performing operations on a serving frequency of the second network based on the connection with the second network; and based on at least one first frequency in the frequency list conflicting the serving frequency of the second network, transmitting, to the first network, a message comprising measurement results for at least one second frequency other than the at least one first frequency in the frequency list.

The present disclosure may have various advantageous effects.

For example, UE may report measurement results for conflicting frequencies with conflict indication, or may not report measurement results for conflicting frequencies. Thus, conflict may be resolved, and data transmission delay may be prevented.

For example, when the MUSIM UE reports the Early Measurement Report to the network, since the UE can check whether one or more frequencies will have a conflict with the configured frequency (i.e. frequency of camping cell or serving cell) of another network due to MUSIM operation, the UE prevents unnecessary data transmission delay caused by the conflict after SCG/SCell activation on the frequencies.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a wireless environment in which a MUSIM device operates according to an embodiment of the present disclosure.

FIG. 9 shows an example of an EMR procedure according to an embodiment of the present disclosure.

FIG. 10 shows an example of a method performed by a UE according to an embodiment of the present disclosure.

FIG. 11 shows an example of a signal flow between UE and network nodes according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

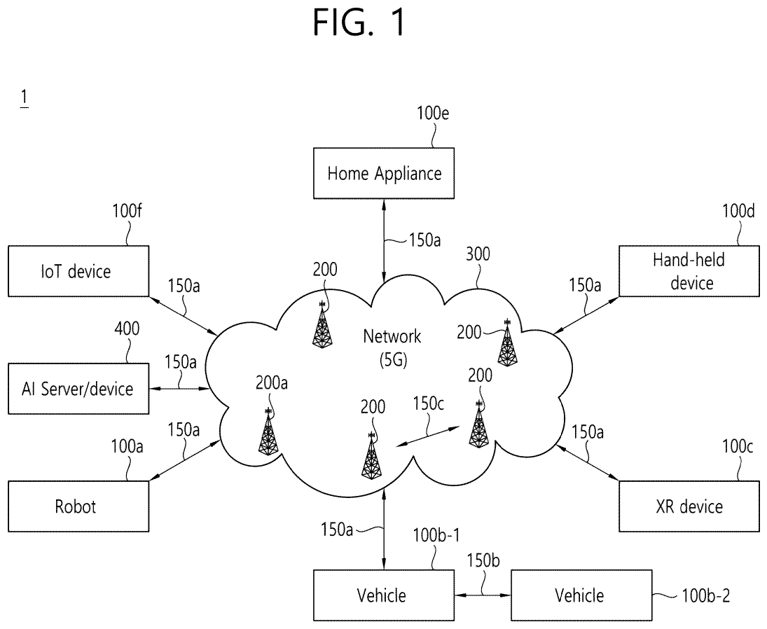

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHZ, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

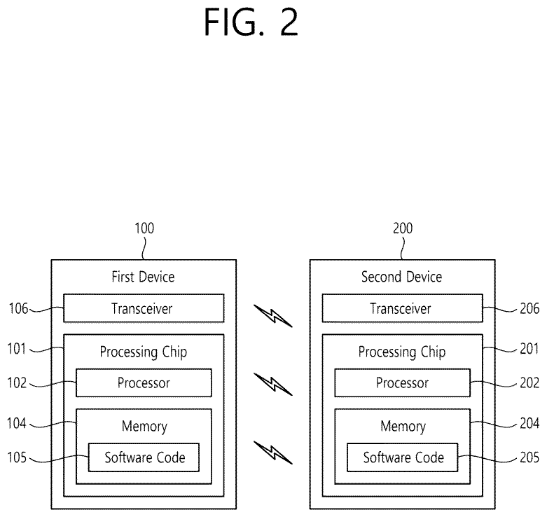

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information i obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

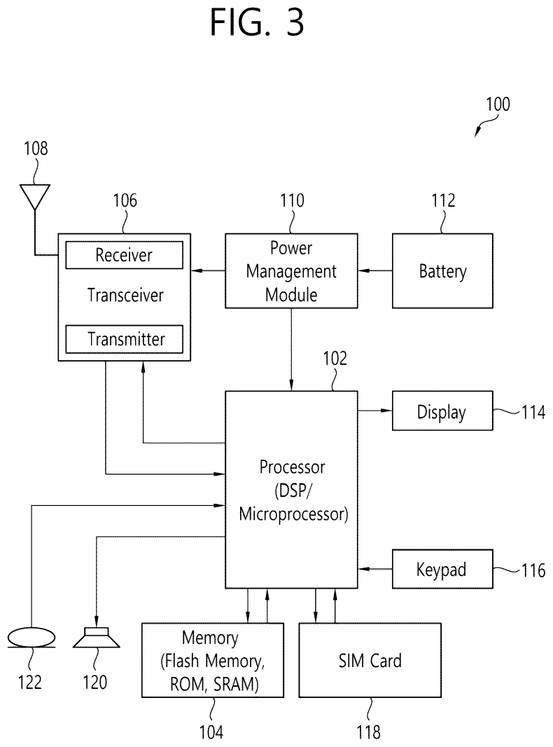

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

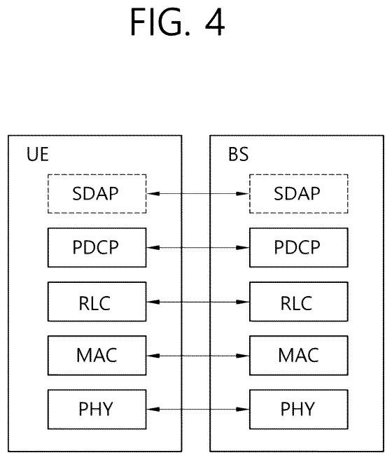

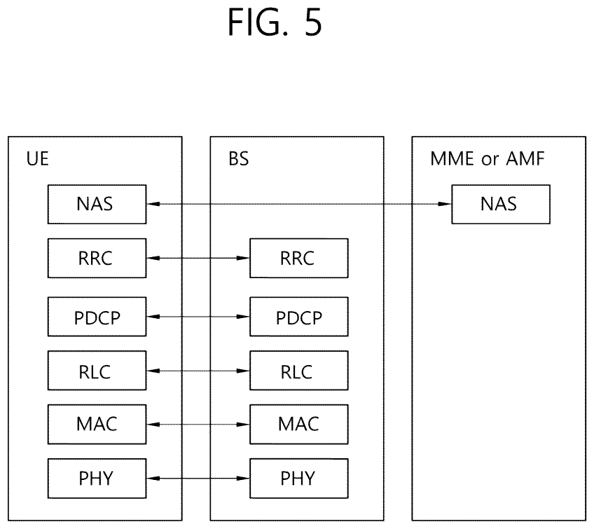

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology (ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

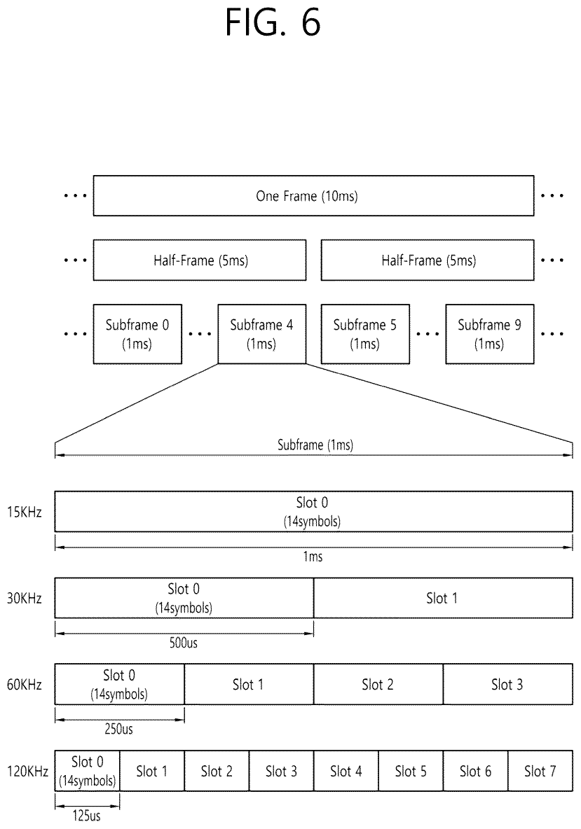

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

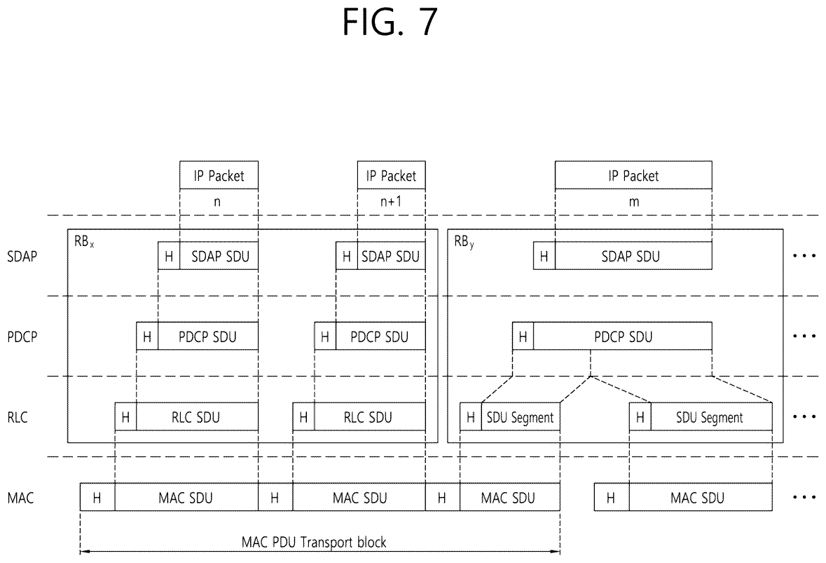

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, contents related to a multi-universal subscriber identity module (MUSIM) is described.

Multi-USIM devices (e.g., MUSIM device 810) have been more and more popular in different countries. The user may have both a personal and a business subscription in one device or have two personal subscriptions in one device for different services.

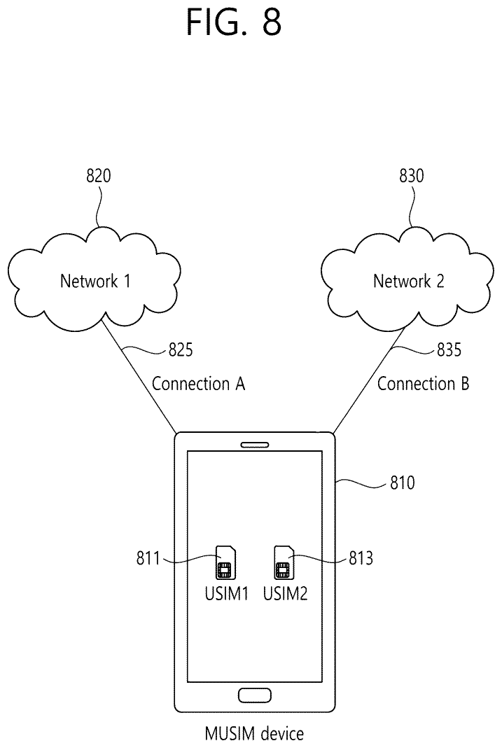

FIG. 8 shows an example of a wireless environment in which a MUSIM device operates according to an embodiment of the present disclosure.

Referring to FIG. 8, MUSIM device 810 (or, MUSIM UE 810) may have a plurality of universal subscriber identity modules (USIMs)-USIM1 811 (or, USIM A 811) and USIM2 813 (USIM B 813). The MUSIM device 810 may register to a network 1 (or, network A) 820 based on subscription information in the USIM1 811 to obtain a connection A 825 between the network 1 820 and the MUSIM device 810. The MSUIM device 810 may also register to a network 2 (or, network B) 830 based on subscription information in the USIM2 813 to obtain a connection B 835 between the network 2 830 and the MUSIM device 810. The MUSIM device 810 may use the USIM1 811 to perform a communication with the network 1 820 over the connection A 825, and use the USIM2 813 to perform a communication with the network 2 830 over the connection B 835.

In a wireless environment in which a MUSIM device operates, the following properties may hold:
Each registration from the USIMS of a MUSIM device may be handled independently.
Each registered USIM in the MUSIM device may be associated with a dedicated international mobile equipment identity (IMEI)/permanent equipment identifier (PEI).
A MUSIM UE may be connected with i) evolved packet system (EPS) on one USIM and 5G system (5GS) on the other USIM; ii) EPS on both USIMs; or iii) 5GS on both USIMs.
A MUSIM UE may be a single reception (RX)/dual RX/single transmission (TX)/Dual TX UE. Single RX may allow the MUSIM UE to receive traffic from only one network at one time. Dual RX may allow the MUSIM UE to simultaneously receive traffic from two networks. Single TX may allow the MUSIM UE to transmit traffic to one network at one time. Dual TX may allow the MUSIM UE to simultaneously transmit traffic to two networks. The terms single RX/TX and Dual RX/TX do not refer to a device type. A single UE may, as an example, use Dual TX in some cases but Single TX in other case.
If/when the multiple USIMs in the MUSIM device are served by different serving networks, network coordination between the serving networks may not be required.
A MUSIM device with different USIMs may be camping with all USIMs on the same serving network RAN node, or the MUSIM device may be camping on different serving networks RAN nodes.
USIMs may belong to same or different operators. Coordination between involved operators may not be required.
USIM may be a physical SIM or embedded SIM (eSIM).

While actively communicating with a first system/network, a MUSIM UE may need to periodically monitor a second system/network (e.g. to synchronize, read the paging channel, perform measurements, or read the system information). The periodical activity on the second system may or may not have performance impact on the first system the UE is communicating with, depending on the UE implementation (i.e., single reception (Rx) or dual Rx).

In some cases, the UE equipped with different USIMs may have paging collisions which results in missed paging. When the UE receives a page in the second system while actively communicating with the first system, the UE may need to decide whether the UE should respond to this paging or not. When the UE decides to respond to the paging in the second system, the UE may need to stop the current activity in the first system. For example, the first system may suspend or release the ongoing connection with the UE.

For MUSIM operation, a MUSIM device in RRC_CONNECTED state in Network A may have to switch from Network A to Network B. For example, Network A may be NR and Network B can either be E-UTRA or NR. Before switching from Network A, a MUSIM device should notify Network A to either leave RRC_CONNECTED state, or be kept in RRC_CONNECTED state in Network A while temporarily switching to Network B.

For example, when configured to do so, a MUSIM device can signal to the Network A a preference to leave RRC_CONNECTED state by using RRC or NAS signalling. After sending a preference to leave RRC_CONNECTED state by using RRC signalling, if the MUSIM device does not receive an RRCRelease message from the Network A within a certain time period (configured by the Network A), the MUSIM device can enter RRC_IDLE state in Network A.

For example, when configured to do so, a MUSIM device can signal to the Network A a preference to be temporarily switching to Network B while remaining in RRC_CONNECTED state in Network. This is indicated by scheduling gaps preference. This preference can include information for setup or release of gap(s). The Network A can configure at most 4 gap patterns for MUSIM purpose: three periodic gaps and a single aperiodic gap. The Network A should always provide at least one of the requested gap pattern or no gaps. Network may provide an alternative gap pattern instead of the one requested by the UE.

In the present disclosure, if UE's capability does not support simultaneously performing operations on a first radio resource and operations on a second radio resource, it may be referred to as there is a capability conflict between the first radio resource and the second radio resource, and/or the first radio resource conflicts the second radio resource. The capability conflict may occur in MUSIM operation, for example, between the first radio resource in network A and the second radio resource in network B.

Hereinafter, early measurement reporting (EMR) is described. For example, the EMR may comprise UE reporting measurement results to a network when establishing or resuming a connection with the network.

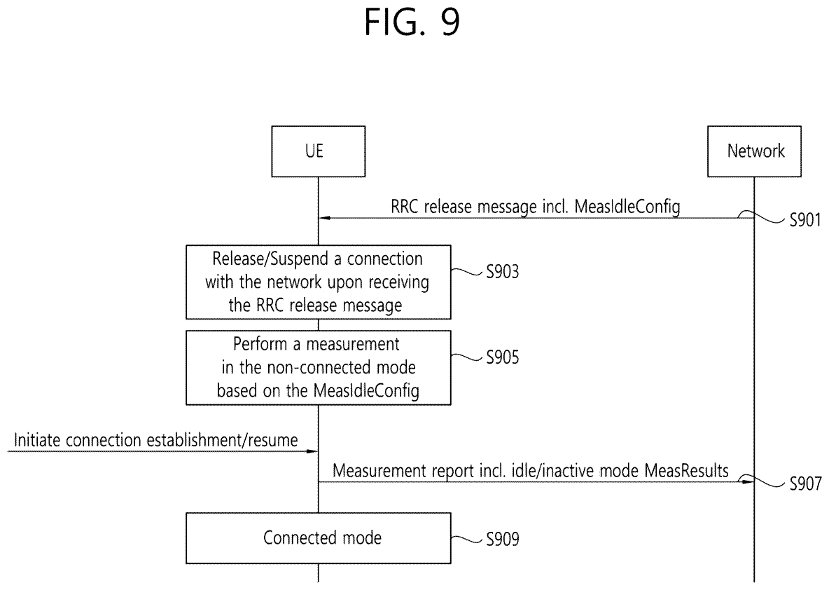

FIG. 9 shows an example of an EMR procedure according to an embodiment of the present disclosure.

Referring to FIG. 9, in step S901, UE may receive an RRC release message (i.e., RRCRelease) from a network. The RRC release message may comprise a measurement configuration for non-connected mode (i.e., measIdleConfig). The measurement configuration for non-connected mode may comprise at least one of an indication to perform a measurement in the non-connected mode, or a frequency list to be measured during the non-connected mode (i.e., measIdleCarrierListNR/measIdleCarrierListEUTRA). The non-connected mode may comprise at least one of inactive mode (e.g., RRC_INACTIVE) or idle mode (i.e., RRC_IDLE). Upon receiving the RRC release message, the UE shall:
1> if the RRCRelease includes the measIdleConfig:
2> if T331 is running:
3> stop timer T331;
2> if the measIdleConfig is set to setup:
3> store the received measIdleDuration in VarMeasIdleConfig;
3> start timer T331 with the value set to measIdleDuration;
3> if the measIdleConfig contains measIdleCarrierListNR:
4> store the received measIdleCarrier ListNR in VarMeasIdleConfig;
3> if the measIdleConfig contains measIdleCarrierListEUTRA:
4> store the received measIdleCarrier ListEUTRA in VarMeasIdleConfig;
3> if the measIdleConfig contains validityAreaList:
4> store the received validityAreaList in VarMeasIdleConfig;

In step S903, the UE may release/suspend a connection with the network upon receiving the RRC release message. For example, the UE may release the connection with the network and enter idle mode upon receiving the RRC release message. For another example, the UE may suspend the connection with the network and enter inactive mode upon receiving the RRC release message.

In step S905, the UE may perform a measurement in the non-connected mode based on the measurement configuration for non-connected mode. The UE may perform a measurement for the frequency list in the measurement configuration, and obtain measurement results related to the non-connected mode. The UE in RRC_IDLE or in RRC_INACTIVE may derive RSRP and RSRQ measurement results per cell associated to carriers based on parameters configured in measIdleCarrierListNR/measIdleCarrier ListEUTRA within VarMeasIdleConfig.

In step S907, the UE may report the measurement results related to the non-connected mode when establishing/resuming the connection with the network.

For example, the UE may report the measurement results related to the non-connected mode when establishing the connection with the network. UE may receive RRCSetup message from a network in a RRC connection establishment procedure, and may transmit RRCSetupComplete message comprising an availability of the measurement results related to the non-connected mode (i.e., idleMeasAvailable). Then, the UE may receive a UEInformationRequest message. Based on the UEInformationRequest message comprising a request to report the measurement results related to the non-connected mode (i.e., idleModeMeasurementReq), the UE may transmit UEInformationResponse message comprising the measurement results related to the non-connected mode.

For example, the UE may report the measurement results related to the non-connected mode when resuming the connection with the network. UE may receive RRCResume message from a network in a RRC connection resume procedure. Based on the RRCResume message comprising a request to report the measurement results related to the non-connected mode (i.e., idleModeMeasurementReq), the UE may transmit RRCResumeComplete message comprising the measurement results related to the non-connected mode. Based on the RRCResume message not comprising a request to report the measurement results related to the non-connected mode, the UE may transmit RRCResumeComplete message comprising an availability of the measurement results related to the non-connected mode (i.e., idleMeasAvailable). Then, the UE may receive a UEInformationRequest message. Based on the UEInformationRequest message comprising a request to report the measurement results related to the non-connected mode (i.e., idleModeMeasurementReq), the UE may transmit UEInformationResponse message comprising the measurement results related to the non-connected mode.

In step S909, the UE may be in connected mode (i.e., RRC_CONNECTED).

Hereinafter, SCell activation/deactivation mechanism is described.

To enable reasonable UE battery consumption when CA is configured, an activation/deactivation mechanism of Cells is supported. When an SCell is deactivated, the UE does not need to receive the corresponding PDCCH or PDSCH, cannot transmit in the corresponding uplink, nor is it required to perform CQI measurements. Conversely, when an SCell is active, the UE shall receive PDSCH and PDCCH (if the UE is configured to monitor PDCCH from this SCell) and is expected to be able to perform CQI measurements. NG-RAN ensures that while PUCCH SCell (a Secondary Cell configured with PUCCH) is deactivated, SCells of secondary PUCCH group (a group of SCells whose PUCCH signalling is associated with the PUCCH on the PUCCH SCell) should not be activated. NG-RAN ensures that SCells mapped to PUCCH SCell are deactivated before the PUCCH SCell is changed or removed. When reconfiguring the set of serving cells:
SCells added to the set are initially activated or deactivated;
SCells which remain in the set (either unchanged or reconfigured) do not change their activation status (activated or deactivated).

At handover or connection resume from RRC_INACTIVE:
SCells are activated or deactivated.

To enable reasonable UE battery consumption when BA is configured, only one UL BWP for each uplink carrier and one DL BWP or only one DL/UL BWP pair can be active at a time in an active serving cell, all other BWPs that the UE is configured with being deactivated. On deactivated BWPs, the UE does not monitor the PDCCH, does not transmit on PUCCH, PRACH and UL-SCH.

To enable fast SCell activation when CA is configured, one dormant BWP can be configured for an SCell. If the active BWP of the activated SCell is a dormant BWP, the UE stops monitoring PDCCH and transmitting SRS/PUSCH/PUCCH on the SCell but continues performing CSI measurements, AGC and beam management, if configured. A DCI is used to control entering/leaving the dormant BWP for one or more SCell(s) or one or more SCell group(s).

The dormant BWP is one of the UE's dedicated BWPs configured by network via dedicated RRC signalling. The SpCell and PUCCH SCell cannot be configured with a dormant BWP.

To enable fast SCell activation when CA is configured, aperiodic CSI-RS for tracking for fast SCell activation can be configured for an SCell to assist AGC and time/frequency synchronization. A MAC CE is used to trigger activation of one or more SCell(s) and trigger the aperiodic CSI-RS for tracking for fast SCell activation for a (set of) deactivated SCell(s).

If the MAC entity is configured with one or more SCells, the network may activate and deactivate the configured SCells. Upon configuration of an SCell, the SCell is deactivated unless the parameter sCellState is set to activated for the SCell by upper layers.

The configured SCell(s) is activated and deactivated by:
receiving the SCell Activation/Deactivation MAC CE;
receiving the Enhanced SCell Activation/Deactivation MAC CE;
configuring sCellDeactivationTimer timer per configured SCell (except the SCell configured with PUCCH, if any): the associated SCell is deactivated upon its expiry;
configuring sCellState per configured SCell: if configured, the associated SCell is activated upon SCell configuration;
receiving scg-State: the SCells of SCG are deactivated.

The MAC entity shall for each configured SCell:
1> if an SCell is configured with sCellState set to activated upon SCell configuration, or an SCell Activation/Deactivation MAC CE or an Enhanced SCell Activation/Deactivation MAC CE is received activating the SCell:
2> if the SCell was deactivated prior to receiving this Enhanced SCell Activation/Deactivation MAC CE and a TRS is indicated for this SCell:
3> indicate to lower layers the information regarding the TRS.
2> if the SCell was deactivated prior to receiving this SCell Activation/Deactivation MAC CE or this Enhanced SCell Activation/Deactivation MAC CE; or
2> if the SCell is configured with sCellState set to activated upon SCell configuration:
3> if firstActiveDownlinkBWP-Id is not set to dormant BWP:
4> activate the SCell according to the timing for MAC CE activation and according to the timing for direct SCell activation; i.e. apply normal SCell operation including:
5> SRS transmissions on the SCell;
5> CSI reporting for the SCell;
5> PDCCH monitoring on the SCell;
5> PDCCH monitoring for the SCell;
5> PUCCH transmissions on the SCell, if configured.
3> else (i.e. firstActiveDownlinkBWP-Id is set to dormant BWP):
4> stop the bwp-InactivityTimer of this Serving Cell, if running.
3> activate the DL BWP and UL BWP indicated by firstActiveDownlinkBWP-Id and firstActive UplinkBWP-Id respectively.
2> start or restart the sCellDeactivationTimer associated with the SCell according to the timing for MAC CE activation and according to the timing for direct SCell activation;
2> if the active DL BWP is not the dormant BWP:
3> (re-)initialize any suspended configured uplink grants of configured grant Type 1 associated with this SCell according to the stored configuration, if any, and to start in the symbol;
3> trigger PHR.
1> else if an SCell Activation/Deactivation MAC CE or an Enhanced SCell Activation/Deactivation MAC CE is received deactivating the SCell; or
1> if the sCellDeactivationTimer associated with the activated SCell expires; or
1> if the SCG associated with the activated SCell is deactivated: 2> deactivate the SCell;
2> stop the sCellDeactivationTimer associated with the SCell;
2> stop the bwp-InactivityTimer associated with the SCell;
2> deactivate any active BWP associated with the SCell;
2> clear any configured downlink assignment and any configured uplink grant Type 2 associated with the SCell respectively;
2> clear any PUSCH resource for semi-persistent CSI reporting associated with the SCell;
2> suspend any configured uplink grant Type 1 associated with the SCell;
2> flush all HARQ buffers associated with the SCell;
2> cancel, if any, triggered consistent LBT failure for the SCell.
1> if PDCCH on the activated SCell indicates an uplink grant or downlink assignment; or
1> if PDCCH on the Serving Cell scheduling the activated SCell indicates an uplink grant or a downlink assignment for the activated SCell; or
1> if a MAC PDU is transmitted in a configured uplink grant and LBT failure indication is not received from lower layers; or
1> if a MAC PDU is received in a configured downlink assignment:
2> restart the sCellDeactivationTimer associated with the SCell.
1> if the SCell is deactivated:
2> not transmit SRS on the SCell;
2> not report CSI for the SCell;
2> not transmit on UL-SCH on the SCell;
2> not transmit on RACH on the SCell;
2> not monitor the PDCCH on the SCell;
2> not monitor the PDCCH for the SCell;
2> not transmit PUCCH on the SCell.

HARQ feedback for the MAC PDU containing SCell Activation/Deactivation MAC CE or Enhanced SCell Activation/Deactivation MAC CE shall not be impacted by PCell, PSCell and PUCCH SCell interruptions due to SCell activation/deactivation.

When SCell is deactivated, the ongoing Random Access procedure on the SCell, if any, is aborted.

Meanwhile, the MUSIM function may support a scenario in which both SIM A (i.e., network A) and SIM B (i.e., network B) establish each RRC connection and transmit/receive data at the same time.

In this scenario, the network A may configure a measurement idle configuration, i.e., measIdleConfig, to support the fast SCell activation based on the early measurement reporting which comprises the measurement results in RRC_IDLE/RRC_INACTIVE state according to the measurement idle configuration.

If some measurement results of frequencies are reported to the network A via the early measurement reporting and the measurement results of the frequencies can lead to a temporary hardware conflict for the UE due to operations in the certain frequency of the network B, SCell data transmission of the frequencies may be delayed even though the network commands the fast SCell activation.

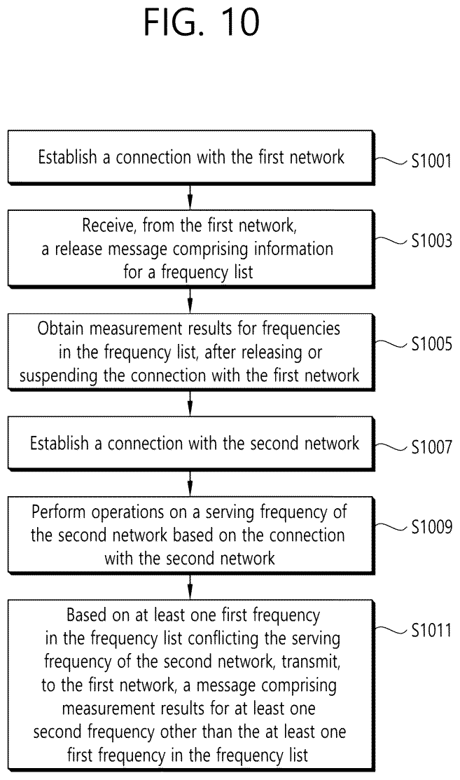

FIG. 10 shows an example of a method performed by a UE according to an embodiment of the present disclosure. The method may also be performed by a wireless device.

Referring to FIG. 10, in step S1001, the UE may establish a connection with a first network.

In step S1003, the UE may receive, from the first network, a release message comprising information for a frequency list.

In step S1005, the UE may obtain measurement results for frequencies in the frequency list, after releasing or suspending the connection with the first network.

In step S1007, the UE may establish a connection with a second network. For example, the UE may determine a MUSIM switching and/or a network switching from the first network and the second network, and establishing the connection with the second network based on the determination.

In step S1009, the UE may perform operations on a serving frequency of the second network based on the connection with the second network.

In step S1011, based on at least one first frequency in the frequency list conflicting the serving frequency of the second network, the UE may transmit, to the first network, a message comprising measurement results for at least one second frequency other than the at least one first frequency in the frequency list.

According to various embodiments, the at least one first frequency conflicting the serving frequency of the second network may comprise a capability of the UE being not able to support simultaneously performing operations on the at least one first frequency and operations on the serving frequency of the second network. The at least one first frequency may conflict the serving frequency of the second network based on at least one of: a case that the at least one first frequency is adjacent to the serving frequency of the second network; a case the at least one first frequency at least partially overlaps the serving frequency of the second network; or a case that the at least one first frequency comprises the serving frequency of the second network.

According to various embodiments, the UE may discard measurement results for the at least one first frequency. The message may not comprise the measurement results for the at least one first frequency.

According to various embodiments, the message may further comprise at least one of: measurement results for the at least one first frequency; or a conflict indication for each of the at least one first frequency. The message may further comprise a cause of the conflict indication set to a multiple universal subscriber identity module (MUSIM) operation associated with the first network and the second network.

According to various embodiments, the message comprising the measurement results for the at least one second frequency may be transmitted in a UE information procedure.

For example, the UE may release the connection with the first network upon receiving the release message from the first network. The UE may receive, from the first network, radio resource control (RRC) setup message. The UE may transmit, to the first network, an RRC setup complete message comprising an availability of measurement results stored in the UE. The UE may receive, from the first network during the UE information procedure, a UE information request message comprising a request to report measurement results stored in the UE. The UE may transmit, to the first network during the UE information procedure, a UE information response message comprising the measurement results for the at least one second frequency.

For example, the UE may suspend the connection with the first network upon receiving the release message from the first network. The UE may receive, from the first network, radio resource control (RRC) resume message. The UE may transmit, to the first network, an RRC resume complete message comprising an availability of measurement results stored in the UE. The UE may receive, from the first network during the UE information procedure, a UE information request message comprising a request to report measurement results stored in the UE. The UE may transmit, to the first network during the UE information procedure, a UE information response message comprising the measurement results for the at least one second frequency.

According to various embodiments, the message comprising the measurement results for the at least one second frequency may be transmitted during a radio resource control (RRC) resume procedure.

For example, the UE may suspend the connection with the first network upon receiving the release message from the first network. The UE may receive, from the first network during the RRC resume procedure, a radio resource control (RRC) resume message comprising a request to report measurement results stored in the UE. The UE may transmit, to the first network during the RRC resume procedure, a RRC resume complete message comprising the measurement results for the at least one second frequency.

According to various embodiments, the UE may be a multiple universal subscriber identity module (MUSIM) UE equipped with USIMs comprising a first SIM and a second SIM. The UE may register to the first network based on subscription information stored in the first SIM. The UE may register to the second network based on subscription information stored in the second SIM.

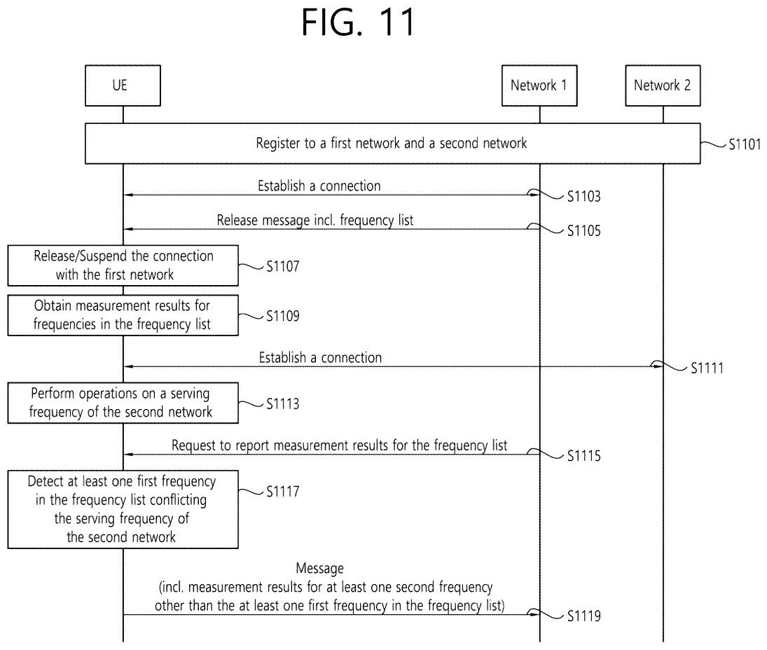

FIG. 11 shows an example of a signal flow between UE and network nodes according to an embodiment of the present disclosure. The network nodes man comprise a network node in a first network (i.e., network 1) and a network node in a second network (i.e., network 2), and each network node may comprise a base station (BS).

Referring to FIG. 11, in step S1101, the UE may register to a first network and a second network.

In step S1103, the network node in the first network may establish a connection with the UE.

In step S1105, the network node in the first network may transmit, to the UE, a release message comprising information for a frequency list.

In step S1107, the UE may release/suspend the connection with the first network.

In step S1109, the UE may obtain measurement results for frequencies in the frequency list.

In step S1111, the network node in the first network may establish a connection with the UE.

In step S1113, the UE may perform operations on a serving frequency of the second network.

In step S1115, the network node in the first network may transmit, to the UE, a request to report measurement results for the frequency list.

In step S1117, the UE may detect at least one first frequency in the frequency list conflicting the serving frequency of the second network.

In step S1119, the network node may receive, from the UE, a message comprising measurement results for at least one second frequency other than the at least one first frequency in the frequency list.

Hereinafter, methods for reporting measurement results when conflict occurs in MUSIM operations are described.

### Method 1) Partial Reporting of Early Measurement Results

According to implementations of the present disclosure, while performing Multi-USIM operation, when a UE is requested by a first network to report available early measurement results, the UE may determine if the early measurement results may lead to a CA/DC configuration that cannot be fully supported (i.e., incomplete CA/DC configuration) due to the capability conflict/limitation caused by the capability used for operations with a second network.

If the UE determines that the measurement results may lead to the problem such as incomplete CA/DC configuration and/or capability conflict, the UE may select measurement results of the available early measurement results and report the selected results to the first network such that the reported results are not expected to lead to such problem.

For selecting measurement results to report, the UE may exclude some stored early measurement results related to at least one frequency that may cause such problem, if a serving cell is configured on that frequency for CA/DC in the first network or if radio resources related to the frequency are configured in the first network.

For selecting measurement results to report, the UE may discard all stored early measurement results if available measurement results include measurement results related to at least one frequency that may cause such problem, if a serving cell is configured on that frequency for CA/DC in the first network or if radio resources related to the frequency are configured in the first network.

After excluding or discarding the measurement results, no measurement results may be selected for the early measurement reporting. If this case happens during RRC connection resume, the UE may not include any early measurement results in the RRC resume complete message. If the case happens during RRC connection establishment, the UE may not include availability indication in RRC setup complete message indicating that early measurement results are available.

In some implementations, the UE shall perform the following actions upon reception of the RRCSetup:
1> set the content of RRCSetupComplete message as follows:
2> if the SIBI contains idleModeMeasurementsNR and the UE has NR idle/inactive measurement information concerning cells other than the PCell available in VarMeasIdleReport; or
2> if the SIBI contains idleModeMeasurementsEUTRA and the UE has E-UTRA idle/inactive measurement information available in VarMeasIdleReport:
3> for each entry in measIdleCarrierListNR within VarMeasIdleConfig that contains ssb-MeasConfig:
4> if carrierFreq in measIdleCarrierListNR occurs or will occur the temporary hardware conflict (i.e. the UE's reduced capability change is or will be required) while MUSIM operation:
5> discard the stored measurement results of the carrierFreq in measIdleCarrierListNR in VarMeasIdleReport;
3> for each entry in measIdleCarrier ListEUTRA within VarMeasIdleConfig:
4> if carrierFreqEUTRA in measIdleCarrierListEUTRA occurs or will occur the temporary hardware conflict (i.e. the UE's reduced capability change is or will be required) while MUSIM operation:
5> discard the stored measurement results of the carrierFreqEUTRA in measIdleCarrierListEUTRA in VarMeasIdleReport;
3> if the UE still has NR idle/inactive measurement information concerning cells other than the PCell available in VarMeasIdleReport, or
3> if the UE still has EUTRA idle/inactive measurement information concerning cells other than the PCell available in VarMeasIdleReport:
4> include the idleMeasAvailable;
1> submit the RRCSetupComplete message to lower layers for transmission, upon which the procedure ends.

In some implementations, upon receiving the RRCResume message, the UE shall:
1> set the content of the of RRCResumeComplete message as follows:
2> if the UE has idle/inactive measurement information concerning cells other than the PCell available in VarMeasIdleReport:
3> if the idleModeMeasurementReq is included in the RRCResume message:
4> for each entry in measIdleCarrierListNR within VarMeasIdleConfig that contains ssb-MeasConfig:
5> if carrierFreq in measIdleCarrierListNR occurs or will occur the temporary hardware conflict (i.e. the UE's reduced capability change is or will be required) while MUSIM operation:
6> discard the stored measurement results of the carrierFreq in measIdleCarrierListNR in VarMeasIdleReport;
4> for each entry in measIdleCarrier ListEUTRA within VarMeasIdleConfig:
5> if carrierFreqEUTRA in measIdleCarrierListEUTRA occurs or will occur the temporary hardware conflict (i.e. the UE's reduced capability change is or will be required) while MUSIM operation:
6> discard the stored measurement results of the carrierFreqEUTRA in measIdleCarrierListEUTRA in VarMeasIdleReport;
4> set the measResultIdleEUTRA in the RRCResumeComplete message to the value of meas ReportIdleEUTRA in the VarMeasIdleReport, if available;
4> set the measResultIdleNR in the RRCResumeComplete message to the value of meas ReportIdleNR in the VarMeasIdleReport, if available;
4> discard the e VarMeasIdleReport upon successful delivery of the RRCResumeComplete message is confirmed by lower layers;
3> else:
4> if the SIBI contains idleModeMeasurementsNR and the UE has NR idle/inactive measurement information concerning cells other than the PCell available in VarMeasIdleReport, or
4> if the SIBI contains idleModeMeasurementsEUTRA and the UE has E-UTRA idle/inactive measurement information available in VarMeasIdleReport:
5> for each entry in measIdleCarrierListNR within VarMeasIdleConfig that contains ssb-MeasConfig:
6> if carrierFreq in measIdleCarrierListNR occurs or will occur the temporary hardware conflict (i.e. the UE's reduced capability change is or will be required) while MUSIM operation:
7> discard the stored measurement results of the carrierFreq in measIdleCarrierListNR in VarMeasIdleReport;
5> for each entry in measIdleCarrier ListEUTRA within VarMeasIdleConfig:
6> if carrierFreqEUTRA in measIdleCarrierListEUTRA occurs or will occur the temporary hardware conflict (i.e. the UE's reduced capability change is or will be required) while MUSIM operation:
7> discard the stored measurement results of the carrierFreqEUTRA in measIdleCarrierListEUTRA in VarMeasIdleReport;
5> if the UE still has NR idle/inactive measurement information concerning cells other than the PCell available in VarMeasIdleReport, or
5> if the UE still has E-UTRA idle/inactive measurement information available in VarMeasIdleReport:
6> include the idleMeasAvailable;
1> submit the RRCResumeComplete message to lower layers for transmission

In some implementations, upon receiving the UEInformationRequest message, the UE shall, only after successful security activation:
1> if the idleModeMeasurementReq is included in the UEInformationRequest and the UE has stored VarMeasIdleReport that contains measurement information concerning cells other than the PCell:
2> for each entry in measIdleCarrierListNR within VarMeasIdleConfig that contains ssb-MeasConfig:
3> if carrierFreq in measIdleCarrierListNR occurs or will occur the temporary hardware conflict (i.e. the UE's reduced capability change is or will be required) while MUSIM operation:
4> discard the stored measurement results of the carrierFreq in measIdleCarrierListNR in VarMeasIdleReport;
2> for each entry in measIdleCarrier ListEUTRA within VarMeasIdleConfig:
3> if carrierFreqEUTRA in measIdleCarrierListEUTRA occurs or will occur the temporary hardware conflict (i.e. the UE's reduced capability change is or will be required) while MUSIM operation:
4> discard the stored measurement results of the carrierFreqEUTRA in measIdleCarrierListEUTRA in VarMeasIdleReport;
2> set the measResultIdleEUTRA in the UEInformationResponse message to the value of measReportIdleEUTRA in the VarMeasIdleReport, if available;

2> set the measResultIdleNR in the UEInformationResponse message to the value 2> of meas ReportIdleNR in the VarMeasIdleReport, if available;
2> discard the VarMeasIdleReport upon successful delivery of the UEInformationResponse message confirmed by lower layers;
1> submit the UEInformationResponse message to lower layers for transmission.
   Method 2) Indication of Capability Conflict with Full Early Measurement Results.

According to implementations of the present disclosure, while performing Multi-USIM operation, when a UE is requested by a first network to report available early measurement results, the UE may determine if the early measurement results may lead to a CA/DC configuration that cannot be fully supported (i.e., incomplete CA/DC configuration) due to the capability conflict/limitation caused by the capability used for operations with a second network.

If the UE determines that the measurement results may lead to the problem such as incomplete CA/DC configuration and/or capability conflict, the UE may report available early measurement results but also include information to indicate that the early measurement results may lead to the problem such as incomplete CA/DC configuration and/or capability conflict. The information may indicate that the problem is due to MUSIM operation. The information may include indication(s) to indicate frequency(ies) that would be problematic, if configured as a serving frequency or if radio resources of the frequency are used in the first network. This frequency indication can be included in the measurement result per frequency. The network may want frequency information containing this indication to early check which frequency list the UE currently has the temporary hardware conflict because of the MUSIM operation.

In some implementations, upon receiving the RRCResume message, the UE shall:
1> set the content of the of RRCResumeComplete message as follows:
2> if the UE has idle/inactive measurement information concerning cells other than the PCell available in VarMeasIdleReport:
3> if the idleModeMeasurementReq is included in the RRCResume message:
4> for each entry in measIdleCarrierListNR within VarMeasIdleConfig that contains ssb-MeasConfig:
5> if carrierFreq in measIdleCarrierListNR occurs or will occur the temporary hardware conflict (i.e. the UE's reduced capability change is or will be required) while MUSIM operation:
6> set temporaryRestrictionRequired (e.g. 1-bit indication) in the carrierFreq in measIdleCarrierListNR in VarMeasIdle Report;
4> for each entry in measIdleCarrier ListEUTRA within VarMeasIdleConfig:
5> if carrierFreqEUTRA in measIdleCarrierListEUTRA occurs or will occur the temporary hardware conflict (i.e. the UE's reduced capability change is or will be required) while MUSIM operation:
6> set temporaryRestrictionRequired (e.g. 1-bit indication) in the carrierFreqEUTRA in measIdleCarrierListEUTRA in VarMeasIdleReport;
4> set the measResultIdleEUTRA in the RRCResumeComplete message to the value of meas ReportIdleEUTRA in the VarMeasIdleReport, if available;
4> set the measResultIdleNR in the RRCResumeComplete message to the value of measReportIdleNR in the VarMeasIdleReport, if available;
4> discard the VarMeasIdleReport upon successful delivery of the RRCResumeComplete message is confirmed by lower layers;
3> else:
4> if the SIBI contains idleModeMeasurementsNR and the UE has NR idle/inactive measurement information concerning cells other than the PCell available in VarMeasIdleReport, or
4> if the SIBI contains idleModeMeasurementsEUTRA and the UE has E-UTRA idle/inactive measurement information available in VarMeasIdleReport:
5> include the idleMeasAvailable;
1> submit the RRCResumeComplete message to lower layers for transmission.

In some implementations, upon receiving the UEInformationRequest message, the UE shall, only after successful security activation:
1> if the idleModeMeasurementReq is included in the UEInformationRequest and the UE has stored VarMeasIdleReport that contains measurement information concerning cells other than the PCell:
2> for each entry in measIdleCarrierListNR within VarMeasIdleConfig that contains ssb-MeasConfig:
3> if carrierFreq in measIdleCarrierListNR occurs or will occur the temporary hardware conflict (i.e. the UE's reduced capability change is or will be required) while MUSIM operation:
4> set temporaryRestrictionRequired (e.g. 1-bit indication) in the carrierFreq in measIdleCarrierListNR in VarMeasIdleReport;
2> for each entry in measIdleCarrier ListEUTRA within VarMeasIdleConfig:
3> if carrierFreqEUTRA in measIdleCarrierListEUTRA occurs or will occur the temporary hardware conflict (i.e. the UE's reduced capability change is or will be required) while MUSIM operation:
4> set temporaryRestrictionRequired (e.g. 1-bit indication) in the carrierFreqEUTRA in measIdleCarrierListEUTRA in VarMeasIdleReport;
2> set the measResultIdleEUTRA in the UEInformationResponse message to the value of meas ReportIdleEUTRA in the VarMeasIdleReport, if available;
2> set the measResultIdleNR in the UEInformationResponse message to the value of meas ReportIdleNR in the VarMeasIdleReport, if available;
2> discard the VarMeasIdleReport upon successful delivery of the UEInformationResponse message confirmed by lower layers;
1> submit the UEInformationResponse message to lower layers for transmission.

Furthermore, the method in perspective of the UE described in the present disclosure (e.g., in FIG. 10) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving, from a first network, a release message comprising information for a frequency list; obtaining measurement results for frequencies in the frequency list, after releasing or suspending the connection with the first network; establishing a connection with a second network; performing operations on a serving frequency of the second network based on the connection with the second network; and based on at least one first frequency in the frequency list conflicting the serving frequency of the second network, transmitting, to the first network, a message comprising measurement results for at least one second frequency other than the at least one first frequency in the frequency list.

Furthermore, the method in perspective of the UE described in the present disclosure (e.g., in FIG. 10) may be performed by a software code 105 stored in the memory 104 included in the first wireless device 100 shown in FIG. 2.

More specifically, at least one computer readable medium (CRM) stores instructions that, based on being executed by at least one processor, perform operations comprising: establishing a connection with a first network; receiving, from the first network, a release message comprising information for a frequency list; obtaining measurement results for frequencies in the frequency list, after releasing or suspending the connection with the first network; establishing a connection with a second network; performing operations on a serving frequency of the second network based on the connection with the second network; and based on at least one first frequency in the frequency list conflicting the serving frequency of the second network, transmitting, to the first network, a message comprising measurement results for at least one second frequency other than the at least one first frequency in the frequency list.

Furthermore, the method in perspective of the UE described in the present disclosure (e.g., in FIG. 10) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: establishing a connection with a first network; receiving, from the first network, a release message comprising information for a frequency list; obtaining measurement results for frequencies in the frequency list, after releasing or suspending the connection with the first network; establishing a connection with a second network; performing operations on a serving frequency of the second network based on the connection with the second network; and based on at least one first frequency in the frequency list conflicting the serving frequency of the second network, transmitting, to the first network, a message comprising measurement results for at least one second frequency other than the at least one first frequency in the frequency list.

Furthermore, the method in perspective of the network node in a first network described in the present disclosure (e.g., in FIG. 11) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: establishing a connection with a user equipment (UE); transmitting, to the UE, a release message comprising information for a frequency list; transmitting, to the UE, a request to report measurement results for the frequency list; and receiving, from the UE, a message comprising measurement results for at least one second frequency other than at least one first frequency in the frequency list, wherein the at least one first frequency conflicts a serving frequency of a second network, wherein the UE is configured to establish a connection with the second network and perform operations on the serving frequency of the second network based on the connection with the second network. The present disclosure may have various advantageous effects.

For example, UE may report measurement results for conflicting frequencies with conflict indication, or may not report measurement results for conflicting frequencies. Thus, conflict may be resolved, and data transmission delay may be prevented.

For example, when the MUSIM UE reports the Early Measurement Report to the network, since the UE can check whether one or more frequencies will have a conflict with the configured frequency (i.e. frequency of camping cell or serving cell) of another network due to MUSIM operation, the UE prevents unnecessary data transmission delay caused by the conflict after SCG/SCell activation on the frequencies.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) configured to operate in a wireless communication system, the method comprising:
establishing a connection with a first network;
receiving, from the first network, a release message comprising information for a frequency list;
obtaining measurement results for frequencies in the frequency list, after releasing or suspending the connection with the first network;
establishing a connection with a second network;
performing operations on a serving frequency of the second network based on the connection with the second network; and
based on at least one first frequency in the frequency list conflicting the serving frequency of the second network, transmitting, to the first network, a message comprising measurement results for at least one second frequency other than the at least one first frequency in the frequency list.

2. The method of claim 1, wherein the at least one first frequency conflicting the serving frequency of the second network comprises a capability of the UE being not able to support simultaneously performing operations on the at least one first frequency and operations on the serving frequency of the second network.

3. The method of claim 1, wherein, the at least one first frequency conflicts the serving frequency of the second network based on at least one of:
a case that the at least one first frequency is adjacent to the serving frequency of the second network;
a case the at least one first frequency at least partially overlaps the serving frequency of the second network; or
a case that the at least one first frequency comprises the serving frequency of the second network.

4. The method of claim 1, further comprising:
discarding measurement results for the at least one first frequency,
wherein the message does not comprise the measurement results for the at least one first frequency.

5. The method of claim 1, wherein the message further comprises at least one of:
measurement results for the at least one first frequency; or
a conflict indication for each of the at least one first frequency.

6. The method of claim 5, wherein the message further comprises a cause of the conflict indication set to a multiple universal subscriber identity module (MUSIM) operation associated with the first network and the second network.

7. The method of claim 1, wherein the message comprising the measurement results for the at least one second frequency is transmitted during a UE information procedure.

8. The method of claim 7, further comprising:
releasing the connection with the first network upon receiving the release message from the first network;
receiving, from the first network, radio resource control (RRC) setup message;
transmitting, to the first network, an RRC setup complete message comprising an availability of measurement results stored in the UE; and
receiving, from the first network during the UE information procedure, a UE information request message comprising a request to report measurement results stored in the UE,
wherein the transmitting of the message comprises transmitting, to the first network during the UE information procedure, a UE information response message comprising the measurement results for the at least one second frequency.

9. The method of claim 7, further comprising:
suspending the connection with the first network upon receiving the release message from the first network;
receiving, from the first network, radio resource control (RRC) resume message;
transmitting, to the first network, an RRC resume complete message comprising an availability of measurement results stored in the UE; and
receiving, from the first network during the UE information procedure, a UE information request message comprising a request to report measurement results stored in the UE,
wherein the transmitting of the message comprises transmitting, to the first network during the UE information procedure, a UE information response message comprising the measurement results for the at least one second frequency.

10. The method of claim 1, wherein the message comprising the measurement results for the at least one second frequency is transmitted during a radio resource control (RRC) resume procedure.

11. The method of claim 10, further comprising:
suspending the connection with the first network upon receiving the release message from the first network;
receiving, from the first network during the RRC resume procedure, a radio resource control (RRC) resume message comprising a request to report measurement results stored in the UE
wherein the transmitting of the message comprises transmitting, to the first network during the RRC resume procedure, a RRC resume complete message comprising the measurement results for the at least one second frequency.

12. The method of claim 1, wherein the UE is a multiple universal subscriber identity module (MUSIM) UE equipped with USIMs comprising a first SIM and a second SIM, further comprising:
registering to the first network based on subscription information stored in the first SIM; and
registering to the second network based on subscription information stored in the second SIM.

13. The method of claim 1, wherein the UE is in communication with at least one of a mobile device, a network, or autonomous vehicles.

14. A user equipment (UE) configured to operate in a wireless communication system, the UE comprising:
at least one transceiver;
at least one processor; and
at least one memory operatively coupled to the at least one processor and storing instructions that, based on being executed by the at least one processor, perform operations comprising:
establishing a connection with a first network;
receiving, from the first network, a release message comprising information for a frequency list;
obtaining measurement results for frequencies in the frequency list, after releasing or suspending the connection with the first network;
establishing a connection with the second network;
performing operations on a serving frequency of the second network based on the connection with a second network; and
based on at least one first frequency in the frequency list conflicting the serving frequency of the second network, transmitting, to the first network, a message comprising measurement results for at least one second frequency other than the at least one first frequency in the frequency list.

15. (canceled)

16. A network node in a first network configured to operate in a wireless communication system, the network node comprising:
at least one transceiver;
at least one processor; and
at least one memory operatively coupled to the at least one processor and storing instructions that, based on being executed by the at least one processor, perform operations comprising:
establishing a connection with a user equipment (UE);
transmitting, to the UE, a release message comprising information for a frequency list;
transmitting, to the UE, a request to report measurement results for the frequency list; and
receiving, from the UE, a message comprising measurement results for at least one second frequency other than at least one first frequency in the frequency list,
wherein the at least one first frequency conflicts a serving frequency of a second network, and
wherein the UE is configured to establish a connection with the second network and perform operations on the serving frequency of the second network based on the connection with the second network.

17-20. (canceled)
